(19) United States
(12) Patent Application Publication
(10) Pub. No.: US 2025/0111152 A1
(43) Pub. Date: Apr. 3, 2025

(54) SYSTEMS AND METHODS FOR ANSWERING INQUIRIES USING VECTOR EMBEDDINGS AND LARGE LANGUAGE MODELS

(71) Applicant: INTUIT INC., Mountain View, CA (US)

(72) Inventors: Ankita SINHA, Mountain View, CA (US); Gregory Kenneth COULOMBE, Edmonton, CA (US); Malathy MUTHU, Mountain View, CA (US); Adam NEELEY, Mountain View, CA (US)

(73) Assignee: INTUIT INC., Mountain View, CA (US)

(21) Appl. No.: 18/478,867

(22) Filed: Sep. 29, 2023

(51) Int. Cl. G06F 40/205; H04L 51/02

(52) U.S. Cl. CPC G06F 40/205; H04L 51/02

(57) ABSTRACT

Systems and methods are provided for using vector embeddings and large language models to answer chatbot inquiries.

### BACKGROUND OF THE DISCLOSURE

Many modern organizations and corporations have teams of customer support agents and other types of consumer-facing professionals (e.g., tax professionals) who operate in a customer service environment by personally interacting with customers to address and answer their questions in a live manner. Such interactions usually occur via webchat (i.e., a chatbot) or over the phone. Generally, an overall goal for a customer support agent interacting with a customer seeking assistance is to provide a quick and correct resolution to the customer's inquiry.

Because of the complexity of some customer inquiries, these agents (especially consumer-facing professionals) may frequently need to consult specific resources to obtain the answer the customer is seeking. For example, a tax professional may get a detailed tax-related question from a customer, which could be difficult to answer without consulting tax materials and/or other documents.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of an example system for answering chatbot inquiries using vector embeddings and large language models according to example embodiments of the present disclosure.

FIG. 2 is a block diagram illustrating an example embedded repository that can be used within the system of FIG. 1 according to some embodiments of the present disclosure.

FIG. 3 is a flowchart of an example process for answering chatbot inquiries using vector embeddings and large language models according to example embodiments of the present disclosure.

FIG. 4 is a flowchart of an example process for transmitting a response to a chat agent according to example embodiments of the present disclosure.

FIG. 5 is an exemplary user interface according to some embodiments of the present disclosure.

FIG. 6 is an example server device that can be used within the system of FIG. 1 according to an embodiment of the present disclosure.

FIG. 7 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Providing real-time assistance to consumer-facing professionals can be quite challenging given the substantive nature of the questions they are dealing with. There can be extensive resources to sift through to be able to address certain questions. For example, many of these professionals, while interacting with a consumer, manually attempt to get specific knowledge (e.g., tax knowledge) by posing questions to a communication platform with other professionals, such as Slack® or Discord® or by researching through stores of archives and documentation or the Internet. All of these are undesirable.

Accordingly, embodiments of the present disclosure relate to systems and methods for answering inquiries (e.g., via a chatbot, phone call) using vector embeddings and large language models (LLMs). The disclosed systems and methods can leverage vector embeddings and the generative artificial intelligence of LLMs to facilitate real-time or near real-time access to topic-specific-related information for consumer-facing professionals, such as a tax professional interacting with a consumer over the phone or via chatbot.

In one or more embodiments, the disclosed system can include a comprehensive, enriched dataset encompassing extensive tax-related documents and information and can utilize advanced techniques (e.g., embedding generation, similarity algorithms, vector store optimization, and LLMs) to ensure accurate and contextually relevant responses to user queries. The system can utilize a curated and enriched dataset of tax forms, instructions, business and other tax-related documents, tax data models, tax calculation logic, and interview files embedded into a vector space. The system can monitor a chatbot (e.g., between a tax professional and a consumer) to identify a user query and identify portions of the embedded dataset relevant to the query via various similarity analysis techniques. The system can provide the original user query and identified relevant information as an input to an LLM. The LLM can provide a quick and accurate response to the question, and the system can provide this response to the consumer-facing professional.

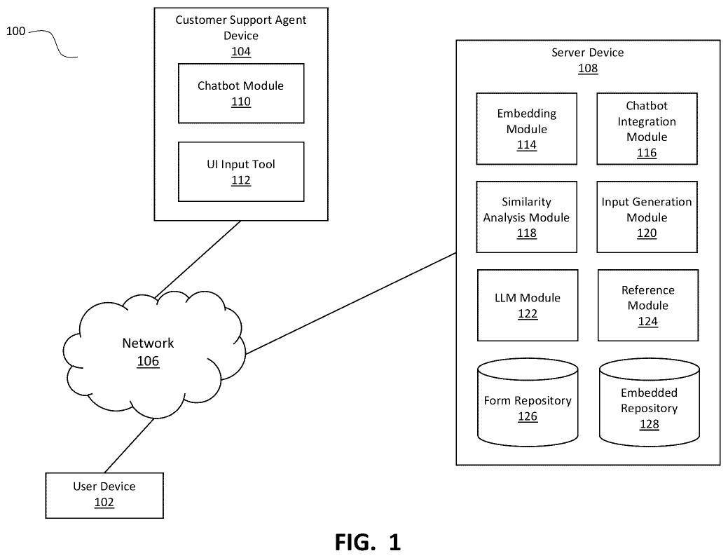

FIG. 1 is a block diagram of an example system 100 for answering inquiries (e.g., via chatbot or phone call) using vector embeddings and large language models according to example embodiments of the present disclosure. The system 100 can include one or more user devices 102 (generally referred to herein as a “user device 102” or collectively referred to herein as “user devices 102”) that can access a customer support agent device 104 via a network 106 to facilitate communication with a customer support agent (e.g., a consumer-facing professional such as a tax professional). In addition, the user device 102 and the customer support agent device 104 are communicably coupled to a server 108. In some embodiments, the system 100 can include any number of user devices 102 and customer support agent devices 104. For example, for a financial or accounting platform or other website that may offer services to users, there may be an extensive userbase with thousands or even millions of users that connect to the system 100 via their user devices 102. The server 108 can monitor a conversation between a user device 102 and a customer support agent 104 and provide assistance to the agent, professional, etc. using the customer support agent device 104.

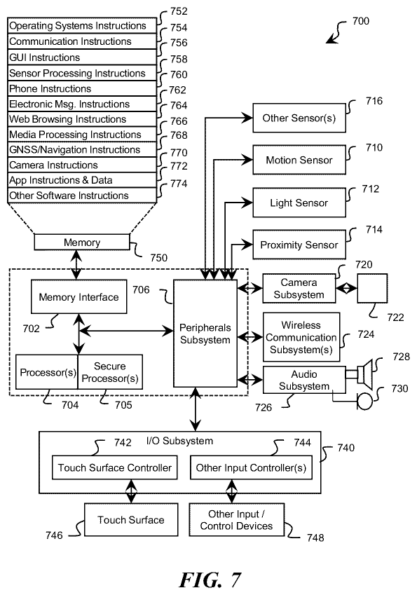

A user device 102 and/or a customer support agent device 104 can include one or more computing devices capable of receiving user input, transmitting and/or receiving data via the network 106, and or communicating with the server 108. In some embodiments, a user device 102 and/or a customer support agent device 104 can be a conventional computer system, such as a desktop or laptop computer. Alternatively, a user device 102 and/or a customer support agent device 104 can be a device having computer functionality, such as a personal digital assistant (PDA), a mobile telephone, a smartphone, or other suitable device. In some embodiments, a user device 102 and/or a customer support agent device 104 can be the same as or similar to the computing device 700 described below with respect to FIG. 7.

The network 106 can include one or more wide areas networks (WANs), metropolitan area networks (MANs), local area networks (LANs), personal area networks (PANs), or any combination of these networks. The network 106 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 106 can also use standard communication technologies and/or protocols.

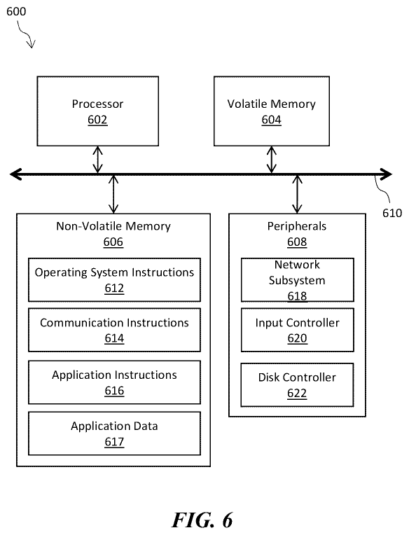

The server 108 may include any combination of one or more of web servers, mainframe computers, general-purpose computers, personal computers, or other types of computing devices. The server 108 may represent distributed servers that are remotely located and communicate over a communications network, or over a dedicated network such as a local area network (LAN). The server 108 may also include one or more back-end servers for carrying out one or more aspects of the present disclosure. In some embodiments, the server 108 may be the same as or similar to server 600 described below in the context of FIG. 6.

As discussed above, a customer support agent device 104 may be associated with a customer support agent or other consumer-facing professional and may allow a customer support agent to communicate with a user operating user device 102. The customer support agent device 104 can be configured to receive inquiries from the user device 102 and send received inquiries to the server 108 via network 106 via the chatbot module 110. In some embodiments, the customer support agent device 104 may be configured to send at least a portion of chat history to server device 108 via network 106 using the UI input tool 112. Further, the customer support agent device 104 may be configured to receive instructions from server device 108 to display search results on a user interface. In some embodiments, the user interface may be Angular JS. In some embodiments, the chatbot module 110 may provide functionality to a customer support agent to compose a message to send to the user device 102.

Similarly, the UI input tool 112 may provide functionality to a customer support agent to compose a message to send to the server 108. In some embodiments, the UI input tool 112 may allow the customer support agent to type in free form text, copy and paste text from displayed search results, or a combination of the two.

As shown in FIG. 1, the server 108 can include an embedding module 114, a chatbot integration module 116, a similarity analysis module 118, an input generation module 120, an LLM module 122, a reference module 124, a form repository 126, and an embedded repository 128.

In some embodiments, the chatbot integration module 116 is configured to monitor the chatbot module 110 of the customer support agent device 104, thereby monitoring and receiving communications between the user device 102 and the customer support agent 104. In some embodiments, the chatbot integration module 116 is also configured to maintain context for up to a certain, pre-defined number (e.g., ten) of follow-up questions within a conversational chain.

In addition, the embedding module 114 is configured to embed text to vector form within a vector space, such as a continuous vector space. The embedding module 114 can receive text from the chatbot integration module 116 (such as a user inquiry from the user device 102 received by the customer support agent device 104 via the chatbot module 110) and generate an embedding of the received text. In some embodiments, the embedding module 114 can utilize a variety of embedding techniques, such as e.g., a word2vec model. The word2vec model may be pre-trained. In some embodiments, the word2vec model may use a continuous bag-of-words approach (CBOW). The word2vec model may be configured to create a “bag-of-words” for each description. A bag-of-words for a description may be a set (e.g., JSON object) that includes every word in the user inquiry and the multiplicity (e.g., the number of times the word appears in the description) of each word. The word2vec model can be configured to predict a vector representation of each word using the context of the word's usage in the inquiry. For example, the word2vec model may consider the surrounding words and the multiplicities but may not use grammar or the order of the words in the description. In some embodiments, the embedding module 114 may include an encoder and/or a neural network architecture to perform the embedding processes.

In some embodiments, the embedding module 114 may use a word2vec model with a skip-gram approach, where a skip-gram approach predicts a focus word within a phrase or sentence. The pre-trained word vectors may be initially trained on a variety of sources, such as e.g., Google News and Wikipedia. In some embodiments, the embedding module 114 may employ other words embedding frameworks such as GloVe (Global Vector) or FastText. GloVe techniques may, rather than predicting neighboring words (CBOW) or predicting the focus word (skip-gram) may embed words such that the dot product of two-word vectors is close to or equal to the log of the number of times appear near each other.

In addition, it is important to note that the disclosed embedding techniques are not limiting and that a variety of other applicable embedding techniques that are known by those of ordinary skill in the art could be used.

In addition, the form repository 126 is configured to operate as a database and/or knowledge base of information relevant to certain specialty areas. For instance, in the field of tax and accounting, the form repository 126 can include a plurality of tax forms, tax instructions, business tax-related documents (e.g., for U.S. states), tax data models, tax calculation logics, interview files, etc. In some embodiments, the form repository 126 can be continuously updated to reflect year-over-year changes throughout the knowledge base. Moreover, the embedding module 114 is configured to process the dataset contained within the form repository 126 to generate embeddings thereof, which can enable capture of the relationships between various tax documents and an efficient extraction of information. Once the dataset contained within the form repository 126 is embedded, it can be stored in the embedded repository 128.

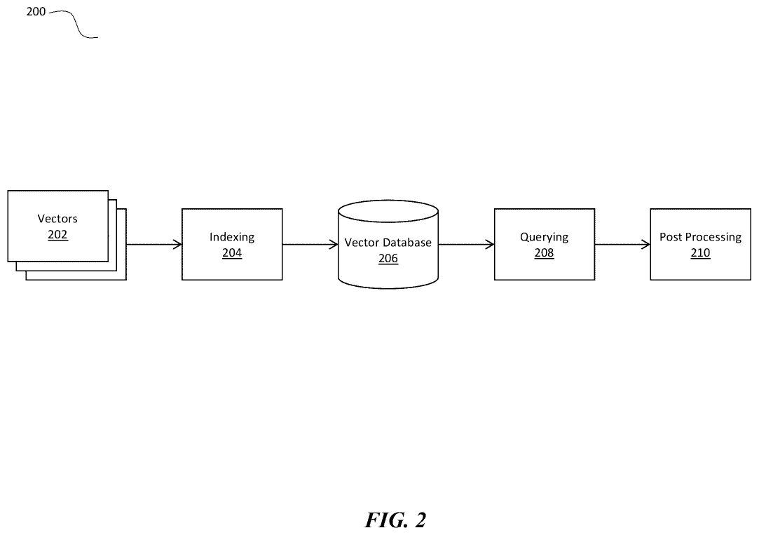

In some embodiments, the embedded repository 128 is a vector store that can be fine-tuned for efficient data retrieval and management. One such example is a Chroma Database. In some embodiments, the embedded repository 128 can employ one or more of indexing and querying techniques that can be used for hierarchical clustering or partitioning. The use of such indexing and querying techniques can enable parallel processing, caching, and prefetching, which can minimize latency to store frequently accessed data in memory. Moreover, this can provide data compression via Apache® Parquet and efficient storage without sacrificing query performance with fault tolerance and recovery. Additional details with respect to the embedded repository 128 are discussed in relation to FIG. 2.

In some embodiments, the similarity analysis module 118 is configured to perform various similarity techniques and algorithms, such as on an embedded user inquiry generated by the embedding module 114 and the embedded dataset contained within the embedded repository 128. In some embodiments, the similarity analysis module 118 can use a combination of cosine similarity and machine learning-based ranking within the vector store. For example, the similarity analysis module 118 may, based on the embedded user inquiry, rank and retrieve the top “n” most relevant documents within the embedded repository 128. In some embodiments, the similarity analysis module 118 can be trained on a corpus of documents, such as a corpus of tax documents. The corpus of documents can include pairs of sentences or phrases along with their similarity scores or labels. In addition, a representative feature vector for each sentence or phrase can be generated using various word embedding techniques or language models. These can then be split into training and validation sets. In some embodiments, a cosine similarity technique can be used to calculate a similarity level between feature vectors of the sentence or phrase pairs in the training set and, optionally, the scores can be normalized between zero and one. Then, a machine learning model (e.g., neural network) can be trained to predict a similarity score based on these sentence or phrase pairs and corresponding cosine similarity scores. In some embodiments, the machine learning model can be trained using techniques such as backpropagation and gradient descent to adjust the model's weights and biases.

In some embodiments, the input generation module 120 is configured to generate an input that can be fed into an LLM (e.g., LLM module 122). For example, the input generation module 120 may analyze the results and/or output of the similarity analysis module 118 and add specific knowledge or other information extracted from the determined forms or documents to a prompt that includes the original user inquiry. In some embodiments, the input generation module 120 can be configured to perform a contextual query expansion on the original user inquiry to generate a set of semantically related terms and/or phrases. This set of terms and/or phrases can be added to the LLM input. The resulting input can therefore include the original user inquiry and additional information defining a subset of forms or other information (as determined by the similarity analysis module 118); this input can then be fed to the LLM module 122.

In some embodiments, the LLM module 122 can include an LLM, such as GPT-3, -3.5, -4, PaLM-E, Ernie Bot, LLaMa, and others. In some embodiments, an LLM can include various transformed-based models trained on vast corpuses of data that utilize an underlying neural network. The LLM module 122 can receive an input, such as the input generated by the input generation module 120. The LLM module 122 is configured to analyze the input to answer the original user inquiry. In some embodiments, the LLM module 122 can be fine-tune using few shot learning with examples specifying how to respond to customer queries and how to provide proper tone, clarity, and specificity.

In some embodiments, the LLM within the LLM module 122 provides various benefits because it is able to continuously learn from user feedback and newly encountered data, as well as update its understanding of the domain-specific knowledge and improve its accuracy in generating responses to inquiries.

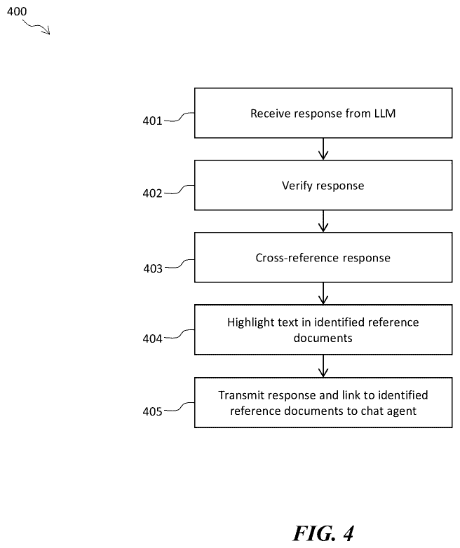

In some embodiments, the reference module 124 is configured to edit and/or modify an output generated by the LLM module 122 prior to it being transmitted to the customer support agent device 104 for display. For example, the reference module 124 can be configured to provide reference documents (i.e., documents utilized or referred to in the LLM module 122′s output) to the customer support agent device 104, such as by inserting a hyperlink highlighting the text excerpts used to answer the original user inquiry. The reference module 124 can also provide access to the underlying source material containing the excerpted text, such as by providing a link to a location in the form repository 126. In addition, the reference module 124 can be configured to perform various verification techniques on the response output generated by the LLM module 122. Additional details on such verification techniques are discussed in relation to FIG. 4.

FIG. 2 is a block diagram illustrating an example embedded repository 200 that can be used within the system 100 according to some embodiments of the present disclosure. The embedded repository 200 can include various vectors 202. For example, the vectors 202 can a vectorized/embedded version of the knowledge base of information contained within the form repository 126. The vectors 202 can have been generated by the embedding module 114. Once the vectors 202 have been generated, an indexing procedure 204 can be performed on them to form the vector database 206. In some embodiments, indexing can include organizing the vectors 202 in such a way that they can be efficiently searched. For example, the indexing can be performed using techniques such as k-d trees and/or hash tables. Additionally, a querying procedure 208 can be used when accessing the vector database (such as by the similarity analysis module 118) to enable various post processing results 210. In some embodiments, the querying can be used when accessing the vector database 206. For example, the querying can include inputting a piece of text (e.g., a query), converting the text into a vector (i.e., embedding the text to the vector space), and then searching the vector database 206 for similar vectors. In some embodiments, similarity can be calculated using measures such as cosine similarity or a Euclidean distance. After calculating the similarity, the various vectors can be ranked based on the similarity scores, and the vectors with the highest scores are considered the most similar.

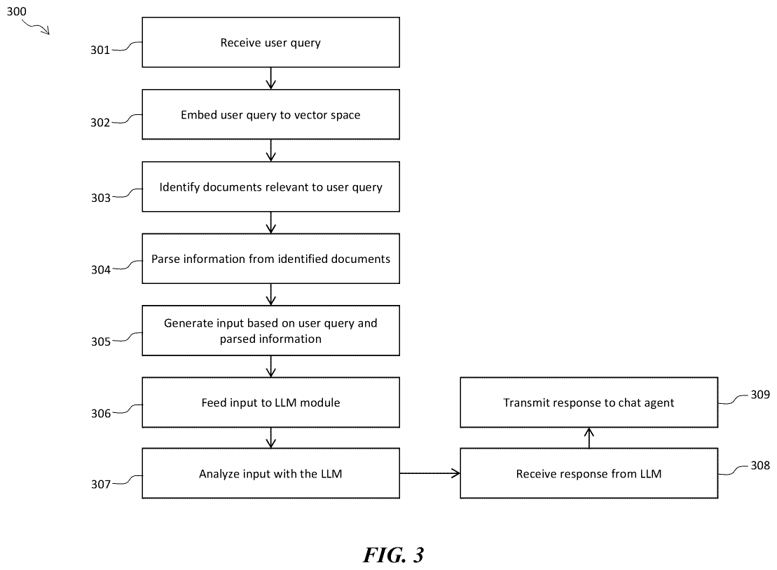

FIG. 3 is a flowchart of an example process 300 for answering chatbot inquiries using vector embeddings and LLMs according to example embodiments of the present disclosure. In some embodiments, process 300 can be performed by the server 108 in conjunction with an ongoing communication between a user device 102 and a customer support agent device 104. For example, a user and a consumer-facing professional may be communicating regarding a specific technical inquiry, such as a tax question, which is received by the chatbot module 110 of the customer support agent device 104.

At block 301, the chatbot integration module 116 receives a user query. For example, the chatbot integration module 116 can be fully integrated with the chatbot module 110 and extract a query from the user device 102 once it is received by the customer support agent device 104. In an alternative embodiment, such as when the consumer-facing professional operating the customer support agent device 104 is engaged in a telephone or other non-textual-based communication with a user that does not utilize the chatbot module 110, the professional may type a user query manually into the UI input tool 112, which is communicably coupled to the server 108. The embedding module 114 can then receive the user query via the UI input tool 112, rather than through the chatbot integration module 116. At block 302, the embedding module 114 embeds the user query to a vector space. In some embodiments, this can include converting the text of the user query to a vector format. The embedding module 114 may perform the embedding procedure via various embedding techniques, such as those discussed in relation to FIG. 1.

At block 303, the similarity analysis module 118 identifies documents relevant to the user query. For example, the similarity analysis module 118 can perform various similarity analysis techniques on the embedded user query to identify and an embedded dataset of forms, documents, and models, such as the embedded repository 128. In some embodiments, the similarity analysis can include a combination of cosine similarity and machine learning-based ranking within the embedded repository 128. For example, the similarity analysis module 118 may, based on the embedded user inquiry, rank and retrieve the top “n” most relevant documents within the embedded repository 128.

At block 304, the input generation module 120 parses the documents identified at block 303 to identify information relevant to the user query. For example, for an identified document, the input generation module 120 can search the entire document and parse its text. The input generation module 120 can compare certain keywords from the received user query to the text within the identified document and retrieve the most relevant passages, for example based on textual similarity scores. The input generation module 120 can parse information such as titles, due dates, submission mechanisms, shareholder/partner types, document purposes, information that the form requires, calculations, instructions, conditions, and the like, although these are not limiting and are merely exemplary in nature.

At block 305, the input generation module 120 generates an input based on the user query and the information parsed from the relevant documents. In some embodiments, the input is generated as an input to an LLM, such as LLM module 122, and is therefore a textual input. In some embodiments, generating the input can include performing a contextual query expansion on the original user inquiry to generate a set of semantically related terms and/or phrases and adding such terms to the input. At block 306, the input generation module 120 feeds the generated input to the LLM module 122, and, at block 307, the LLM module 122 analyzes the query, as well as the additional relevant information provided in the input as context to generate an answer responsive to the user query. At block 308, the server 108 receives the generated response form the LLM module 122 and, at block 309, the server 108 transmits the response to the customer support agent device 104 for display thereof.

FIG. 4 is a flowchart of an example process 400 for transmitting a response to a chat agent according to example embodiments of the present disclosure. In some embodiments, process 400 can be performed by the reference module 124 of server 108 and can be used to verify the accuracy and viability of a response to a user query. In addition, in some embodiments, one or more of the steps in process 400 may be omitted. At block 401, the reference module 124 receives a response to a user query (e.g., the user query received at block 301 of process 300) generated by the LLM module 122. At block 402, the reference module 124 verifies the response, such as through a series of additional prompts. For example, the reference module 124 applies additional prompts as a verification mechanism to ensure the user query is addressed but in a manner that maintains the context of the conversation. At block 403, the reference module 124 cross-references the response to assist in avoiding incorrect or irrelevant information being transmitted to the customer support agent device 104 as part of the response. For example, the reference module 124 can cross-reference the generated response with the information contained in the form repository 126.

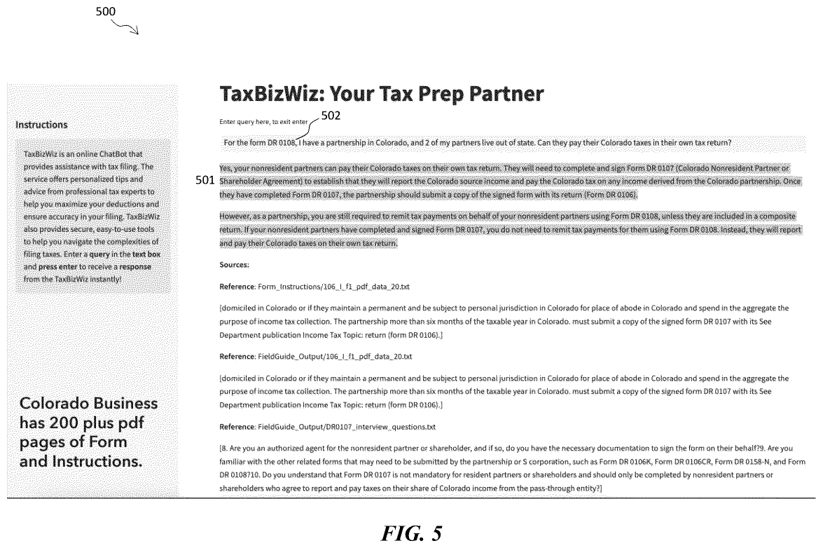

At block 404, the reference module 124 highlights text in one or more reference documents/forms identified as being relevant to the user query. In some embodiments, the highlights can be in a hyperlinked format. For example, the reference module 124 may identify excerpts within the documents/forms identified, for example, at block 303 by the similarity analysis module 118, that were used by the LLM module 122 to answer the user query. An example of highlighted text is shown in FIG. 5 (and discussed below in more detail). At block 405, the reference module 124 transmits the response and hyperlink to the customer support agent device 104 for display.

FIG. 5 is an exemplary user interface 500 according to some embodiments of the present disclosure. In some embodiments, the user interface 500 can be displayed on the customer support agent device 104 after a user query has been received and analyzed by the server 108. The user interface 500 indicates that a form relevant to the user query is form DR 0108 (a statement of Colorado tax remittance for nonresident partner or shareholder), indicated by the title 502, and the form is partially recreated on the user interface 500 with highlighted text 501.

FIG. 6 is a diagram of an example server device 600 that can be used within system 100 of FIG. 1. Server device 600 can implement various features and processes as described herein. Server device 600 can be implemented on any electronic device that runs software applications derived from complied instructions, including without limitation personal computers, servers, smart phones, media players, electronic tablets, game consoles, email devices, etc. In some implementations, server device 600 can include one or more processors 602, volatile memory 604, non-volatile memory 606, and one or more peripherals 608. These components can be interconnected by one or more computer buses 610.

Processor(s) 602 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 610 can be any known internal or external bus technology, including but not limited to ISA, EISA, PCI, PCI Express, USB, Serial ATA, or FireWire. Volatile memory 604 can include, for example, SDRAM. Processor 602 can receive instructions and data from a read-only memory or a random access memory or both. Essential elements of a computer can include a processor for executing instructions and one or more memories for storing instructions and data.

Non-volatile memory 606 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 606 can store various computer instructions including operating system instructions 612, communication instructions 614, application instructions 616, and application data 617. Operating system instructions 612 can include instructions for implementing an operating system (e.g., Mac OS®, Windows®, or Linux). The operating system can be multi-user, multiprocessing, multitasking, multithreading, real-time, and the like. Communication instructions 614 can include network communications instructions, for example, software for implementing communication protocols, such as TCP/IP, HTTP, Ethernet, telephony, etc. Application instructions 616 can include instructions for various applications. Application data 617 can include data corresponding to the applications.

Peripherals 608 can be included within server device 600 or operatively coupled to communicate with server device 600. Peripherals 608 can include, for example, network subsystem 618, input controller 620, and disk controller 622. Network subsystem 618 can include, for example, an Ethernet of WiFi adapter. Input controller 620 can be any known input device technology, including but not limited to a keyboard (including a virtual keyboard), mouse, track ball, and touch-sensitive pad or display. Disk controller 622 can include one or more mass storage devices for storing data files; such devices include magnetic disks, such as internal hard disks and removable disks; magneto-optical disks; and optical disks.

FIG. 7 is an example computing device that can be used within the system 100 of FIG. 1, according to an embodiment of the present disclosure. In some embodiments, device 700 can be user device 102 and/or the customer support agent device 104. The illustrative user device 700 can include a memory interface 702, one or more data processors, image processors, central processing units 704, and or secure processing units 705, and peripherals subsystem 706. Memory interface 702, one or more central processing units 704 and or secure processing units 705, and or peripherals subsystem 706 can be separate components or can be integrated in one or more integrated circuits. The various components in user device 700 can be coupled by one or more communication buses or signal lines.

Sensors, devices, and subsystems can be coupled to peripherals subsystem 706 to facilitate multiple functionalities. For example, motion sensor 710, light sensor 712, and proximity sensor 714 can be coupled to peripherals subsystem 706 to facilitate orientation, lighting, and proximity functions. Other sensors 716 can also be connected to peripherals subsystem 706, such as a global navigation satellite system (GNSS) (e.g., GPS receiver), a temperature sensor, a biometric sensor, magnetometer, or other sensing device, to facilitate related functionalities.

Camera subsystem 720 and optical sensor 722, e.g., a charged coupled device (CCD) or a complementary metal-oxide semiconductor (CMOS) optical sensor, can be utilized to facilitate camera functions, such as recording photographs and video clips. Camera subsystem 720 and optical sensor 722 can be used to collect images of a user to be used during authentication of a user, e.g., by performing facial recognition analysis.

Communication functions can be facilitated through one or more wired and or wireless communication subsystems 724, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 724. The specific design and implementation of communication subsystems 724 can depend on the communication network(s) over which the user device 700 is intended to operate. For example, user device 700 can include communication subsystems 724 designed to operate over a GSM network, a GPRS network, an EDGE network, a WiFi or WiMax network, and a Bluetooth™ network. For example, wireless communication subsystems 724 can include hosting protocols such that device 700 can be configured as a base station for other wireless devices and or to provide a WiFi service.

Audio subsystem 726 can be coupled to speaker 728 and microphone 730 to facilitate voice-enabled functions, such as speaker recognition, voice replication, digital recording, and telephony functions. Audio subsystem 726 can be configured to facilitate processing voice commands, voice-printing, and voice authentication, for example.

I/O subsystem 740 can include a touch-surface controller 742 and or other input controller(s) 744. Touch-surface controller 742 can be coupled to a touch-surface 746. Touch-surface 746 and touch-surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 746.

The other input controller(s) 744 can be coupled to other input/control devices 748, such as one or more buttons, rocker switches, thumb-wheel, infrared port, USB port, and or a pointer device such as a stylus. The one or more buttons (not shown) can include an up/down button for volume control of speaker 728 and or microphone 730.

In some implementations, a pressing of the button for a first duration can disengage a lock of touch-surface 746; and a pressing of the button for a second duration that is longer than the first duration can turn power to user device 700 on or off. Pressing the button for a third duration can activate a voice control, or voice command, module that enables the user to speak commands into microphone 730 to cause the device to execute the spoken command. The user can customize a functionality of one or more of the buttons. Touch-surface 746 can, for example, also be used to implement virtual or soft buttons and or a keyboard.

In some implementations, user device 700 can present recorded audio and or video files, such as MP3, AAC, and MPEG files. In some implementations, user device 700 can include the functionality of an MP3 player, such as an iPod™. User device 700 can, therefore, include a 36-pin connector and or 8-pin connector that is compatible with the iPod. Other input/output and control devices can also be used.

Memory interface 702 can be coupled to memory 750. Memory 750 can include high-speed random access memory and or non-volatile memory, such as one or more magnetic disk storage devices, one or more optical storage devices, and or flash memory (e.g., NAND, NOR). Memory 750 can store an operating system 752, such as Darwin, RTXC, LINUX, UNIX, OS X, Windows, or an embedded operating system such as VxWorks.

Operating system 752 can include instructions for handling basic system services and for performing hardware dependent tasks. In some implementations, operating system 752 can be a kernel (e.g., UNIX kernel). In some implementations, operating system 752 can include instructions for performing voice authentication.

Memory 750 can also store communication instructions 754 to facilitate communicating with one or more additional devices, one or more computers and or one or more servers. Memory 750 can include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic messaging-related process and functions; web browsing instructions 764 to facilitate web browsing-related processes and functions; media processing instructions 766 to facilitate media processing-related functions and processes; GNSS/Navigation instructions 768 to facilitate GNSS and navigation-related processes and instructions; and or camera instructions 770 to facilitate camera-related processes and functions.

Memory 750 can store application (or “app”) instructions and data 772, such as instructions for the apps described above in the context of FIGS. 1-4. Memory 750 can also store other software instructions 774 for various other software applications in place on device 700. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions operable to cause the processor to perform operations comprising:
receiving a query from a user device;
embedding the query to a vector space;
analyzing the query and a vector store comprising a plurality of embedded documents to identify one or more documents relevant to the query;
parsing information from the one or more identified documents;
generating an input based on the user query and the parsed information;
feeding the input to a large language model (LLM);
analyzing the input with the LLM;
receiving an output from the LLM; and
transmitting the output for display on a second computing device.

2. The computing system of claim 1, wherein receiving the query from the user device comprises:
monitoring a chatbot comprising communications between the user device and the second computing device; and
extracting the query from the chatbot.

3. The computing system of claim 1, wherein analyzing the query and the vector store comprises performing a similarity analysis technique on the embedded user query and the plurality of embedded documents.

4. The computing system of claim 3, wherein performing the similarity analysis comprises performing at least one of a cosine similarity and machine learning-based ranking of embedded documents within the plurality of embedded documents.

5. The computing system of claim 4, wherein performing the similarity analysis comprises identifying and ranking a predefined number of relevant embedded documents based on a relevance to the query.

6. The computing system of claim 1, wherein analyzing the query and the vector store comprising the plurality of embedded documents to identify the one or more documents relevant to the query comprises generating a predicted similarity score between the query and at least one of the plurality of embedded documents via a machine learning model trained on vector pairs and corresponding cosine similarity scores.

7. The computing system of claim 1 comprising verifying the output from the LLM by applying one or more prompts to the output.

8. The computing system of claim 1 comprising cross-referencing the output against a database comprising a plurality of documents, the plurality of documents comprising unembedded versions of the plurality of embedded documents.

9. The computing system of claim 1 comprising:
identifying a textual excerpt from one of the one or more identified relevant documents;
highlighting the textual excerpt;
transmitting a hyperlink to the second computing device; and
causing the highlighted textual excerpt to be displayed on the second computing device.

10. The computing system of claim 1, wherein generating the input based on the user query and the parsed information comprises:
performing a contextual expansion of the received query;
generating a set of related terms; and
inserting the generated set of related terms to the input.

11. A computer-implemented method, performed by at least one processor, comprising:
receiving a query from a user device;
embedding the query to a vector space;
analyzing the query and a vector store comprising a plurality of embedded documents to identify one or more documents relevant to the query;
parsing information from the one or more identified documents;
generating an input based on the user query and the parsed information;
feeding the input to a large language model (LLM);
analyzing the input with the LLM;
receiving an output from the LLM; and
transmitting the output for display on a second computing device.

12. The computer-implemented method of claim 11, wherein receiving the query from the user device comprises:
monitoring a chatbot comprising communications between the user device and the second computing device; and
extracting the query from the chatbot.

13. The computer-implemented method of claim 11, wherein analyzing the query and the vector store comprises performing a similarity analysis technique on the embedded user query and the plurality of embedded documents.

14. The computer-implemented method of claim 13, wherein performing the similarity analysis comprises performing at least one of a cosine similarity and machine learning-based ranking of embedded documents within the plurality of embedded documents.

15. The computer-implemented method of claim 14, wherein performing the similarity analysis comprises identifying and ranking a predefined number of relevant embedded documents based on a relevance to the query.

16. The computer-implemented method of claim 11, wherein analyzing the query and the vector store comprising the plurality of embedded documents to identify the one or more documents relevant to the query comprises generating a predicted similarity score between the query and at least one of the plurality of embedded documents via a machine learning model trained on vector pairs and corresponding cosine similarity scores.

17. The computer-implemented method of claim 11 comprising verifying the output from the LLM by applying one or more prompts to the output.

18. The computer-implemented method of claim 11 comprising cross-referencing the output against a database comprising a plurality of documents, the plurality of documents comprising unembedded versions of the plurality of embedded documents.

19. The computer-implemented method of claim 11 comprising:
identifying a textual excerpt from one of the one or more identified relevant documents;
highlighting the textual excerpt;
transmitting a hyperlink to the second computing device; and
causing the highlighted textual excerpt to be displayed on the second computing device.

20. The computer-implemented method of claim 11, wherein generating the input based on the user query and the parsed information comprises:
performing a contextual expansion of the received query;
generating a set of related terms; and
inserting the generated set of related terms to the input.
